(19) United States
(12) Patent Application Publication
(10) Pub. No.: US 2010/0094748 A1
(43) Pub. Date: Apr. 15, 2010

(54) Adjustable risk mitigation system and process for managing a construction loan

(75) Inventors: William S. Cobb, Centennial, CO (US); Wesley F. Hamil, Centennial, CO (US)

Correspondence Address: Edwin H. Crabtree, Suite 575, 3773 Cherry Creek N. Dr., Denver, CO, 80209, US

(73) Assignee: Granite Loan Management of Delaware, LLC

(21) Appl. No.: 12/287,977

(22) Filed: Oct. 14, 2008

(51) Int. Cl. G06Q 40/00

(52) U.S. Cl. 705/38

(57) ABSTRACT

A comprehensive fully integrated adjustable risk mitigation system used for managing a construction loan. The mitigation system includes a communication network computer with website for communicating with a construction lender, via the internet, for receiving plans for a proposed construction project and for displaying documents, related applications and the like to the client and to stakeholders. The network computer includes Audit Application Software for creating an audit application with proprietary business rules and metrics for an analysis of the construction project. The Audit Application Software is also used to generate a completed construction audit application declining or recommending the construction loan for review by the client on the website. The network computer also includes a local area and wide area network web server software programmed with adjustable, updated state statutory requirements pertinent to setup of a construction loan. Further, the web server software contains a draw data proprietary application having adjustable risk mitigation business rules and updated state statutory notice and lien compliance requirements and a proprietary construction site inspection application with construction data for review by the client and the stakeholders on the website.

### BACKGROUND OF THE INVENTION

(a) Field of the Invention

This invention relates to a comprehensive fully-integrated adjustable local area network (LAN), wide area network (WAN) and web-based communication network computer system and process for managing risk related to construction mortgage loans (“construction loans”) for residential and commercial construction projects and more particularly, but not by way of limitation, to an adjustable risk mitigation system and process for overall management of construction loans. The construction loans are entered into between financial institutions, mortgage companies, private funding sources and the like (“construction lenders”) to borrowers for purposes of constructing residential homes or commercial buildings and/or making improvements thereto. The construction loans can be traditional construction mortgage loans or permanent mortgage loans that are modified after closing to interim construction mortgage loans. The risk mitigation system is characterized by a variety of processes and systems including without limitation a process for providing continuous status updates of the construction project, performing building contractor, subcontractor and material supplier (collectively “contractor”) review services, performing budget and project review services, reviewing and processing loan draw requests, preparing and obtaining construction lien waivers, processing and performing visual site inspections, and performing a variety of other key risk mitigation features inherent with any construction project, all with the ability to adjust for changes in circumstances in the construction project and market conditions that may occur before, during or after completion of the construction project.

The system is further distinguished by the ability to conduct in depth pre-loan risk analysis based upon a proprietary set of metrics for construction analysis, which factor in geographic regions, market conditions, and various other criteria including but not limited to project size, construction type and construction quality. The system also provides for the ability to adjust the level of risk managed to a construction lender's tolerance for risk, and additionally incorporates design and workflow components that incorporate evolving statutory mandates in all states where construction projects are located while including industry best practices from a procedural standpoint.

(b) Discussion of Prior Art

Heretofore, construction lenders have been faced with the daunting task of training and securing personnel with a level of knowledge, expertise and experience to identify, assess and successfully manage inherent risks associated with construction projects. The inherent risks include among other things: (1) contractor/builder qualifications and experience; (2) construction project and budget review; (3) independent third party site inspector qualifications and experience; (4) state statutory notice and lien waiver compliance; (5) fund administration and control; (6) assurance of construction project completion; (7) closing permanent financing or modifying construction loans to permanent financing; (8) detailed reporting, reconciliation and management of costs, disbursements and various other items related to a construction project and the corresponding construction loan; and (9) a variety of other construction related risk factors critical to the success of the construction project.

In U.S. Patent Application No: US 2002/0077967 to Ingram et al., an automated construction loan administration system and process is disclosed for controlling a relationship between a borrower and a building inspector. Rather than a direct loan from a lender to a borrower, a system administrator receives funds from the lender and controls the dispersing of the funds to the builder and suppliers using a web-based network.

In U.S. Patent Application Publication No: US 2002/0107788 to Cunningham, an application and payment electronic database system for a lender and a builder is described. The lender uses a host server to obtain credit approval of the builder along with a password and an account number for accessing and entering construction project information.

In U.S. Patent Application Publication No: US 2007/0130064 to Strauss, another construction loan system and process is described for controlling distribution of funds during a building project. Requests for fund draws are analyzed with a funds control agreement and distributed according to the project agreement.

In U.S. Patent Application Publication No: US 2008/0046350 to Allin et al., a construction payment management system and process with automated electronic document generation features are disclosed. The system is designed for managing payments during the construction period and includes generating a budget for the project, generating invoice payments and generating lien wavier statements to suppliers and subcontractors.

The above published patent applications are part of a number of recently filed applications dealing with limited facets of managing a construction loan between a lender and perhaps the contractor, inspector or borrower. The subject adjustable, risk mitigation system and process of managing a construction loan is distinguishable over the above mentioned published applications in that it identifies, analyzes, addresses and manages not one or a limited number of risk components, but, rather is a comprehensive all inclusive system for addressing key risk components critical to the success of residential and commercial construction projects for construction lenders. These components can be called, for example, “Elements of Construction”, or “Fundamentals of Construction” or “Key Components of Construction” and similar descriptive terms. These components are identified, analyzed, and compared to current market conditions and geographic locations and present an adjustable matrix for risk analysis for use by the construction lender. This system further automatically embodies applicable statutory notice and lien requirements for all states and territories in the United States in its workflow procedures; updates such statutory requirements as applicable law evolves; and adjusts parameters according to a construction lender's tolerance for risk. Therefore, the subject system can be called an “Adjustable Risk Mitigation System” for identifying, analyzing, addressing, managing and greatly reducing inherent risks related to construction lending.

### SUMMARY OF THE INVENTION

In view of the foregoing, it is a primary objective of the subject invention to provide a comprehensive adjustable risk mitigation system that is unique and adaptable for changes in market conditions, statutory requirements and construction locations as it relates to a specific construction loan and project. The invention also provides a system of checks and balances to identify, analyze, manage and control a construction lender's potential risk without compromising profit potential. The subject system greatly enhances and supplements the ability of the construction lender's staff and specialists to manage, control and understand the progress of a construction project while minimizing inherent risks associated with the construction loan.

Another object of the risk mitigation system is to facilitate a construction lender's ability to initiate, grow and build a successful construction lending profit center through the internal training of construction loan specialists in the system or the outsourcing of such duties to experienced and qualified third party sources utilizing the system.

Yet another key object of the risk mitigation system is to provide computerized programming, tracking and monitoring capabilities utilizing the defined checks and balances contained in the system. This includes without limitation the ability to: (1) download, complete, sign and submit forms for pre-loan acceptance of the contractor, draw requests, lien waivers and inspections; (2) develop a national tracking and accounting system for contractors; (3) perform pre-loan review of a construction budget and project with recommendations; (4) develop, manage and order site inspections from a network of qualified independent third party inspectors; (5) manage and obtain statutory lien waivers from contractors, subcontractors and material suppliers; (6) develop a system for fund administration that includes a voucher control process for fund control and draw status; (7) obtain project completion assurances; (8) obtain and manage construction project approvals, waivers and other forms and documents; (9) obtain detailed reporting and reconciliation for individual and portfolio construction project accounts; and (10) handle a variety of other tasks designed to mitigate construction loan risk.

These and other objects of the present invention will become apparent to those familiar with the construction lending industry and managing construction projects for or by construction lenders when reviewing the following detailed description, showing novel construction, combination, and elements as herein described, and more particularly defined by the claims, it being understood that changes in the embodiments to the herein disclosed invention are meant to be included as coming within the scope of the claims, except insofar as they may be precluded by the prior art.

### BRIEF DESCRIPTION OF THE DRAWINGS

The accompanying drawings illustrate complete preferred embodiments in the present invention according to the best modes presently devised for the practical application of the principles thereof, and in which:

FIG. 1 illustrates a flow diagram of the subject adjustable risk mitigation system starting with a first step using a web-based communication network computer system for receiving a proposed construction project data from a construction lender which is also referred to herein as a “client”. The data from the client commonly includes project location, size, budget, contractor name, and completion of proprietary review documents. The last step in this drawing shows the completion of an analysis of the project and status data sent to the client via a web server using a proprietary web application.

FIG. 2 illustrates a second flow diagram of the subject system with a first step in this drawing illustrating a start up of an active management of the construction project with final review of the construction loan and directions from the client for delivery to the contractor. The last step in this drawing shows an active draw request displayed on the web server for a Stakeholder review, such as the construction lender, the borrower, the contractor and an active risk management group using proprietary web data documents.

FIG. 3 illustrates a final flow diagram of the subject system with a first step in this drawing illustrating the risk management group ordering an inspection of the construction project. The last step in this drawing shows a final inspection and completion of draw requests for the construction project.

### DETAILED DESCRIPTION OF THE PREFERRED EMBODIMENTS

In the following detailed discussion of the flow diagrams shown in the drawings, the computer system and process steps for the subject adjustable risk mitigation are illustrated in combination and having a general reference numeral 10. For clarity and ease in review, proprietary software running the system's computers is shown in rectangular Boxes having a pair of vertical lines on each side of the Boxes. The process steps, under human control for inputting data into the system's computers and downloading data from the computers for display on a website, have a “Business Process” heading and are shown in rectangular Boxes. Proprietary data is shown in rectangular Boxes with curved vertical sides and is connected to the software. Website review of analyzed data and construction loan status for the client and others using the system and communicating via the web with a client and others is shown in elongated rectangular Boxes with a curved horizontal bottom. Direct communication, via the web, is shown in smaller rectangular Boxes with a curved horizontal bottom. The numeral 10 computer system includes web-based communication network computers, proprietary software, website, web server, user name and password. The organizations networking with the system are shown as “clients”. Clients are construction lenders that include financial lending institutions, banks, saving and loans, investors, mortgage companies and other entities engaged in construction lending. Borrowers, contractors, inspectors and others related to the construction loan process can also access and network with the system. The term “stakeholders” as used herein, can apply to anyone actively engaged in the loan process and having a need to know and includes borrowers, contractors and the like. The network computers in the computer system include proprietary data, proprietary documents and programmed software instrumental in the management of a construction loan. The computer system also includes internal programmed software, distributed across the “local area network or “LAN” and/or the “wide area network or “WAN”, and an external web designed program for networking with the client and others.

The numeral 10 process, using the web-based communication network computers, is operated by trained technical personnel employed by the owner of this patent application by assignment. The technical personnel operating the computer system and managing the construction loan process steps is called the “Risk Management Group” or “RMG”.

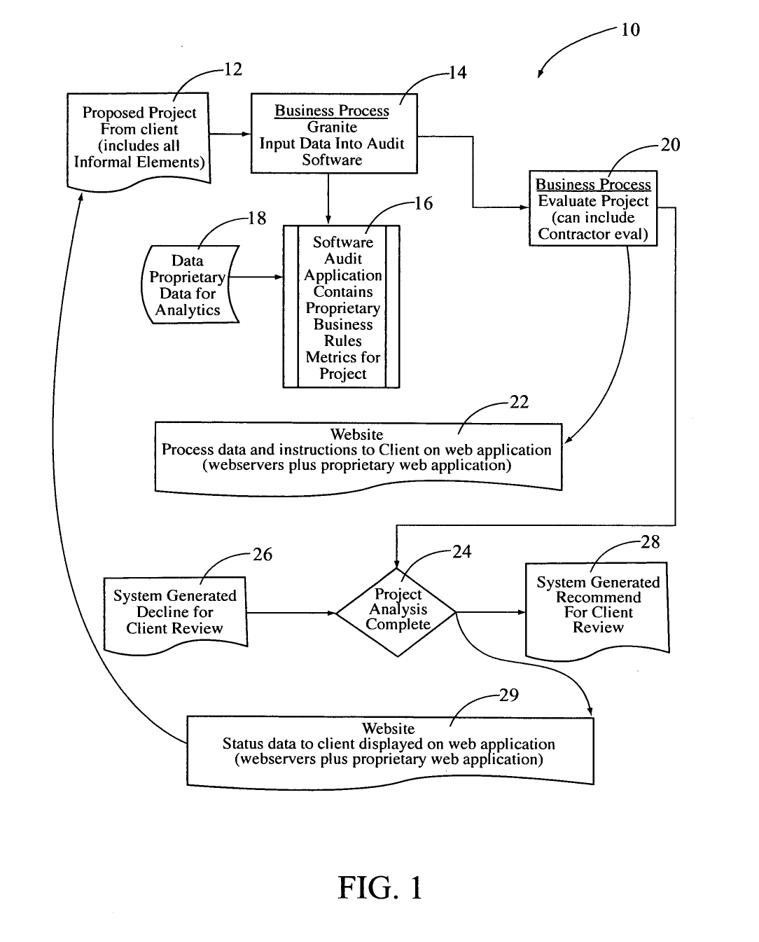

In FIG. 1, the operation of the numeral 10 system and process starts with a proposed construction project with plans, shown in Box 12, sent via the internet from the client to the business process operated by the RMG, as shown as Box 14. Obviously, the construction plans can also be sent by fax and regular mail. The plans commonly include a project location, size, budget, contractor name, and completion of proprietary review documents.

The RMG now inputs the construction plans data to the “Audit Application Software”, as shown in Box 16. The software contains proprietary business rules and metrics for the analysis of the construction project. The software also contains a tunable matrix of market conditions, construction composition, statutory regulations and industry best practices. Further, “Property Data for Analytics”, shown in Box 18, is inputted into the software for supplementing the audit application.

When the audit is completed using the Audit Application Software, the RMG reviews the application and evaluates the project, which can include an evaluation of the contractor, as shown in Box 20. The numeral 10 system then transfers the processed data and instructions to the client and displays the processed data on the web application, using its web server, as shown in Box 22. The RMG also indicates to the client that the project analysis is complete. The completed project review generates, using the numeral 10 system, either a “Decline” of the project for client review, as shown in Box 26, or generates a “Recommended” for client review, as shown in Box 28. The term “Recommended” in Box 28 means the construction project has been evaluated to be compliant with the client's risk management specifications. This compliance may include exceptions deemed acceptable to and by the client, and may be additionally conditioned upon receipt of further documentation, without which the project may be placed in a state of suspension per the RMG. This information as to status data is also displayed and accessible to the client on the web application, as shown in Box 29.

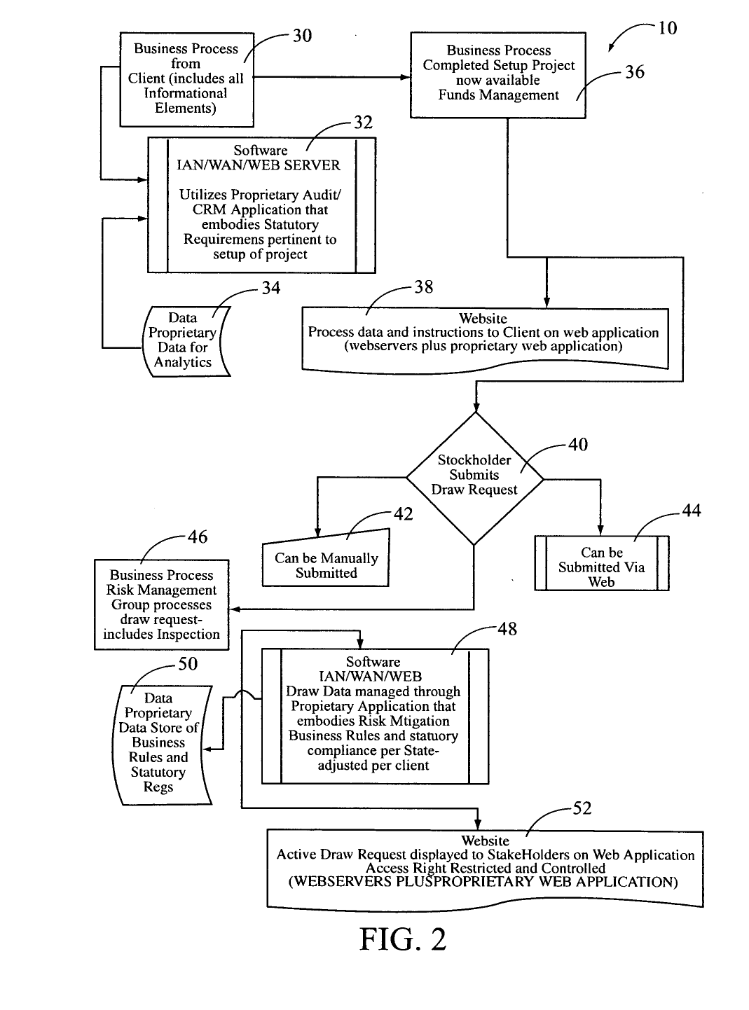

In FIG. 2, the RMG, based on a confirmation from the client to proceed with the loan management, sets up a construction loan project for active management as shown in Box 30. Also at this time, the RMG receives final review comments from the client and any final directions from the client and related to the loan.

The RMG uses proprietary LAN/WAN/WEB SERVER software, as shown in Box 32. This software utilizes a proprietary Audit/CRM application, shown in Box 34, that embodies statutory requirements, which are pertinent to the setup of the loan management project. CRM is customer relationship management software developed, processed, applied and implemented by the inventor to contact and communicate with the client. This software is also supplemented by continuously updated data of applicable statutory requirements for a particular state where a construction project is located, as shown in Box 34.

When the Audit/CRM application is completed and setup of the loan management project is completed, the Business Process is ready for statutory compliant funds management by the RMG, as shown in Box 36. On the system's website, shown in Box 38, the status of the setup of the active management of the project is displayed for the stakeholders.

A stakeholder, for example, the contractor, can now request a draw of construction funds, shown in Box 40. The request for funds can be made manually by telephone or facsimile transmission, as shown in Box 42, or via the web, as shown in Box 44. Unless waived by a client, the borrower must also approve the draw request by using the same procedures as the contractor.

Upon receipt of the draw request, the RMG processes the draw request and orders a construction site inspection, as shown in Box 46. Draw data software, shown in Box 48, is now used to manage a proprietary application that includes risk mitigation business rules and statutory compliance for each state. This software is supplemented by a proprietary store of business rules and statutory regulations, as shown in Box 50. The active draw request can now be displayed to the stakeholders via the website, as shown in Box 52.

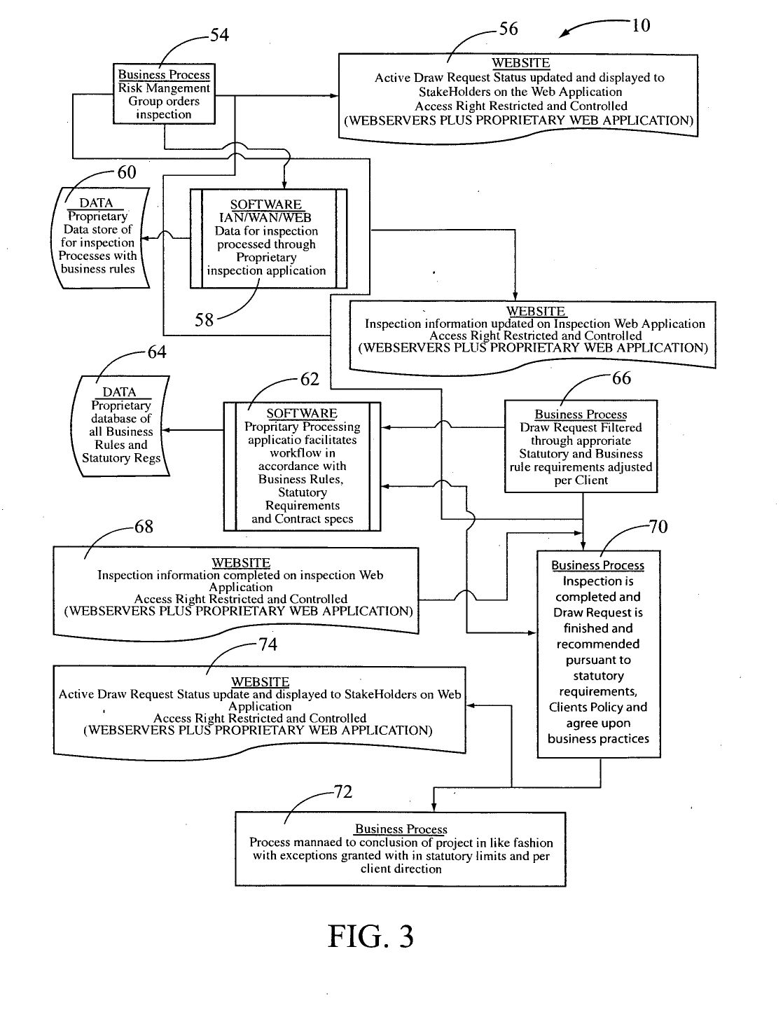

In FIG. 3, the RMG orders an inspection of the progress on the construction site, as shown in Box 54. Also, an active draw request status is updated for the stakeholders and displayed in the web application on the website, as shown in Box 56. Further, inspection information is updated in an inspection web application on the website for stakeholder review, as shown in Box 57.

At this time, the RMG uses the LAN/WAN/WEB software, shown in Box 58, to input construction inspection data using a proprietary inspection application. The software is enhanced by a proprietary data store of inspection processes with business rules, as shown in Box 60. Also at this time, the RMG uses proprietary software, shown in Box 62, for processing the loan application's workflow in accordance with business rules, statutory requirements and contract specifications. This software is supplemented by using a proprietary database of business rules and statutory regulations, as shown in Box 64.

The RMG now filters the draw requests, shown in Box 66, through appropriate statutory and business rule requirements, which can be adjusted by the client. The filtered draw requests also use the software shown in Box 62. The website, shown in Box 68, is now updated for review by the stakeholders of the completed inspection information.

Upon completion of the construction site inspections and draw requests, the RMG makes recommendations to the client for modifying the construction loan to permanent financing (or otherwise closing the permanent financing), closing the permanent financing with exceptions or not closing the permanent financing subject to applicable statutory requirements, client policy and agreed upon permanent financing closing business practices, shown in Box 70. With client approval, the RMG manages the loan process to closing of the permanent financing, with the exceptions granted within statutory limits and per client direction, as shown in Box 72. Also at this time, the active draw request status is updated on the website for stakeholder review, as shown in Box 74.

While the invention has been particularly shown, described and illustrated in detail with reference to the preferred embodiments and modifications thereof, it should be understood by those skilled in the art that equivalent changes in form and detail may be made therein without departing from the true spirit and scope of the invention as claimed except as precluded by the prior art.

The embodiments of the invention for which as exclusive privilege and property: right is claimed are defined as follows:

1. A comprehensive fully integrated adjustable risk mitigation system for managing a construction loan, the mitigation system comprising:
a communication network computer with website, said computer networking, via the internet, with a client for receiving plans for a proposed construction project, said website used for display to the client and to stakeholders;
Audit Application Software programmed in said computer, said Audit Application Software containing proprietary business rules and metrics for an analysis of the construction project, said Audit Application Software generating a completed construction audit application declining or recommending the construction loan for review by the client on the website;
local area and wide area network web server software programmed into said computer, said web server software including adjustable, updated state statutory requirements pertinent to a setup of the construction loan for review by the client and stakeholders on the website;
said web server software containing a draw data proprietary application having adjustable risk mitigation business rules and updated state statutory lien compliance requirements for review by the client and the stakeholders on the website; and
said web server software containing a proprietary construction site inspection application with construction data for review by the client and stakeholders on the website.

2. The mitigation system as described in claim 1 wherein said Audit Application Software is linked to proprietary data for analytics for said construction audit application.

3. The mitigation system as described in claim 1 wherein said web server software is linked to proprietary data for state statutory requirements.

4. The mitigation system as described in claim 1 wherein said web server software is linked to proprietary data for updated business rules and applicable state statutory notice and lien law requirements.

5. The mitigation system as described in claim 1 wherein said web server software is linked to proprietary data for updated state construction site inspections on a nationwide basis and business rules.

6. A process for managing a construction loan using an adjustable risk mitigation system, the mitigation system including a communication network computer with website and internet access for communicating with a client and stakeholders, the steps comprising:
receiving plans for a proposed construction project from the client;
downloading the construction plans into programmed Audit Application Software in the computer, the Audit Application Software containing proprietary business rules and metrics for an analysis of the construction project;
generating a completed construction audit application on the computer for declining or recommending the construction loan, the completed audit application uploaded on the computer for review by the client on the website;
setting up an active management construction project account for an approved construction loan by the client and using a local area and wide area network web server software programmed in the computer;
using the web server software to adjust, update and upload the project account as to State statutory requirements pertinent to the setup of the construction loan for review by the client and stakeholders on the website;
using the web server software for downloading a proprietary draw data application having adjustable risk mitigation business rules and state statutory lien compliance requirements and uploading the draw data application for review by the client and stakeholders on the website; and
using the web server software for downloading a proprietary construction site inspection application with construction data and uploading the inspection application for review by the client and stakeholders on the website.

7. The process as described in claim 6 further including a step of uploading the Audit Application Software with additional proprietary data for analytics and updating the construction audit application for review by the client.

8. The process as described in claim 6 further including a step of uploading the web server software with additional proprietary data with state statutory requirements.

9. The process as described in claim 6 further including a step of uploading the web server software with additional proprietary data with updated business rules and updated applicable state notice and lien law compliance requirements.

10. The process as described in claim 6 further including a step of uploading the web server software with additional proprietary data with updated state construction site inspections and business rules.

11. The process as described in claim 6 further including a step of submitting a draw request by a stakeholder and downloading the draw request into the draw data proprietary application using the web server software.

12. The process as described in claim 11 wherein the draw request is submitted manually by telephone or facsimile.

13. The process as described in claim 11 wherein the draw request is submitted electronically via the internet to the website.

14. The process as described in claim 6 wherein the step of downloading the construction plans into the audit application also includes downloading data related to a contractor evaluation.

15. The process as described in claim 6 further including the step of uploading completed inspection information related to the inspection of the construction site using the web server software for review by the client and stakeholders on the website.

16. The process as described in claim 6 further including the step of uploading updated active draw request status using the web server software for review by the client and stakeholders on the website.

17. A process for managing a construction loan using an adjustable risk mitigation system, the mitigation system including a communication network computer with website and internet access for communicating with a client and a stakeholder, the steps comprising:
receiving plans for a proposed construction project from the client;
downloading the construction plans and data related to a contractor evaluation into programmed audit application software in the computer, the audit application software containing proprietary business rules and metrics for an analysis of the construction project, uploading the audit application software with additional proprietary data for analytics, and updating the construction audit application for review by the client;
generating a completed construction audit application on the computer for declining or recommending the construction loan, the completed audit application uploaded on the computer for review by the client on the website;
setting up an active management construction project account for an approved construction loan by the client using a local area and wide area network web server software programmed in the computer;
using the web server software to adjust, update and upload the project account as to state statutory requirements pertinent to the setup of the construction loan for review by the client and the stakeholders on the website, uploading the web server software with additional proprietary data with state statutory requirements, and also uploading the web server software with additional proprietary data with updated business rules and updated applicable state notice and lien law requirements;
using the web server software for downloading a proprietary draw data application having adjustable risk mitigation business rules and updated state statutory lien compliance requirements and uploading the draw data application and uploading updated active draw request status for review by the client and stakeholders on the website; and
using the web server software for downloading a proprietary construction site inspection application with construction data, uploading the inspection application, and uploading completed inspection information related to the inspection of the construction site for review by the client and stakeholders on the website.

18. The process as described in claim 17 further including a step of uploading the web server software with additional proprietary data with updated state construction site inspections and business rules.

19. The process as described in claim 17 further including a step of submitting a draw request by a stakeholder and downloading the draw request into the draw data proprietary application using the web server software.

20. The process as described in claim 19 wherein the draw request is submitted manually by telephone or facsimile or the draw request is submitted electronically via the internet to the website.
